(19) United States
(12) Patent Application Publication
(10) Pub. No.: US 2026/0126912 A1
(43) Pub. Date: May 7, 2026

(54) MEMORY MODULE AND MEMORY EXPANSION BOARD OF SERVER

(71) Applicant: SUZHOU METABRAIN INTELLIGENT TECHNOLOGY CO., LTD., Suzhou, Jiangsu (CN)

(72) Inventor: Jingtao ZHOU, Suzhou, Jiangsu (CN)

(73) Assignee: SUZHOU METABRAIN INTELLIGENT TECHNOLOGY CO., LTD., Suzhou, Jiangsu (CN)

(21) Appl. No.: 19/122,057

(22) PCT Filed: Mar. 28, 2024
(86) PCT No.: PCT/CN2024/084565

§ 371 Date: Apr. 17, 2025

(30) Foreign Application Priority Data
Jun. 20, 2023 (CN) 202310735217.6

(51) Int. Cl. G06F 3/06

(52) U.S. Cl. CPC G06F 3/061; G06F 3/0655; G06F 3/0673

(57) ABSTRACT

A memory module, and a memory expansion board of a server are provided. The memory module includes: a controller, a first memory channel, and a second memory channel, the controller is connected to the first memory channel and the second memory channel, a compute express link protocol interface configured to be connected to a device conforming to an express link protocol is deployed on the controller. The first memory channel is deployed on a top surface of a memory board, the second memory channel is deployed on a bottom surface of the memory board. The first memory channel includes a plurality of first memory cells, the second memory channel includes a plurality of second memory cells, the plurality of first memory cells and the plurality of second memory cells are in one-to-one correspondence and are laid out in a mirrored manner relative to the memory board.

### CROSS-REFERENCE TO RELATED APPLICATION

The present application claims the priority to the Chinese patent application No. 202310735217.6, titled “MEMORY MODULE AND MEMORY EXPANSION BOARD OF SERVER”, filed to the China National Intellectual Property Administration on Jun. 20, 2023, which is incorporated herein in its entirety by reference.

### TECHNICAL FIELD

Embodiments of the present application relate to the field of computers, and in particular, to a memory module, and a memory expansion board of a server.

### BACKGROUND

With the continuous development of big data, cloud computing and other demands, the density of server computing nodes is continuing to increase. However, the development of the memory expansion technology is far behind the growth rate of the density of computing nodes, and the memory capacities and memory bandwidths evenly allocated to each computing core continues to decline. With the exponential growth of new computing demands such as the Metaverse and Chat Generative Pre-trained Transformer (chatGPT, a natural language processing tool driven by the artificial intelligence technology), the demand for memory capacities is also increasing.

At present, the memory capacity is increased by increasing the capacity of a single memory bank or increasing the number of memory banks. Memory expanders are used to connect a plurality of memory banks to improve memory expansion capabilities. However, since the number of memory particle address lines is limited, the capacity of a single particle is limited, resulting in the capacity of the memory bank not being able to be continuously increased. Considering the cost of a server mainboard and the capability of a Central Processing Unit (CPU) memory controller, the number of memory bank slots may not be continuously increased. The memory expander that connects the plurality of memory banks is relatively large in size, and thus is not easily laid out in the high-density computing nodes.

With respect to the problem of low memory capacities and memory expansion capabilities in the related art, no effective solution has been proposed yet.

### SUMMARY

Embodiments of the present application provide a memory module, and a memory expansion board of a server.

According to a first aspect, provided is a memory module, including: a controller, a first memory channel, and a second memory channel.

The controller is connected to each of the first memory channel and the second memory channel, and a compute express link protocol interface is deployed on the controller, and is configured to be connected to a device conforming to a compute express link protocol.

The first memory channel is deployed on a top surface of a memory board, and the second memory channel is deployed on a bottom of the memory board.

The first memory channel includes a plurality of first memory cells, the second memory channel includes a plurality of second memory cells, and the plurality of first memory cells and the plurality of second memory cells are in one-to-one correspondence and are laid out in a mirrored manner relative to the memory board.

In an exemplary embodiment, the first memory cell is a first memory particle, the second memory cell is a second memory particle, a plurality of first memory particles are evenly divided into N first memory ranks, and a plurality of second memory particles are evenly divided into N second memory ranks, where N is an integer greater than 2.

Each of the first memory ranks includes M first memory particles, and each of the second memory ranks includes M second memory particles.

In an exemplary embodiment, N is 2ⁿ, and n is a positive integer.

In an exemplary embodiment, N is 2, and M is 10; or, N is 4 and M is 10.

In an exemplary embodiment, P of the M first memory particles are configured to process data, Q of the M first memory particles are configured to process error correcting codes, and M is a sum of P and Q.

P of the M second memory particles are configured to process data, and Q of the M second memory particles are configured to process error correcting codes.

In an exemplary embodiment, the first memory particles and the second memory particles all are dynamic memory particles of a double rate protocol 5 with a bit width of x4.

In an exemplary embodiment, each of the dynamic memory particles of the double rate protocol 5 has one of following capacities: 4 Gbit, 8 Gbit, 16 Gbit, 64 Gbit, and 128 Gbit.

In an exemplary embodiment, the first memory cell and the second memory cell both are memory particles.

One or more pairs of symmetrically-arranged data pins are deployed on each memory particle.

Each pair of data pins includes a first data pin and a second data pin.

A first data signal line on the controller which is connected to the first data pin of the memory particle located on the top surface is also connected to the second data pin of the memory particle located on the bottom surface.

A second data signal line on the controller which is connected to the second data pin of the memory particle located on the top surface is also connected to the first data pin of the memory particle located on the bottom surface.

In an exemplary embodiment, one or more pairs of symmetrically-arranged control pins are also deployed on each memory particle.

Each pair of control pins includes a first control pin and a second control pin.

A first control signal line on the controller which is connected to the first control pin of the memory particle located on the top surface is also connected to the second control pin of the memory particle located on the bottom surface.

A second control signal line on the controller which is connected to the second control pin of the memory particle located on the top surface is also connected to the first control pin of the memory particle located on the bottom surface.

In an exemplary embodiment, a mirror control pin is also deployed on each memory particle.

The controller is further connected to the mirror control pin of each memory particle.

The controller is configured to send a first control signal to the mirror control pin of the memory particle located on the top surface, and to send a second control signal to the mirror control pin of the memory particle located on the bottom surface, where the first control signal is used for setting the memory particle located on the top surface to operate in a default mode, and the second control signal is used for setting the memory particle located on the bottom surface to operate in a signal cross-exchange mode.

According to a second aspect, provided is a memory expansion board of a server, including: a memory board, a memory expansion controller, a first memory channel, and a second memory channel.

The memory expansion controller is connected to each of the first memory channel and the second memory channel, and a compute express link protocol interface is deployed on the memory expansion controller, and is configured to be connected to a server.

The memory expansion controller and the first memory channel are deployed on a top surface of the memory board, and the second memory channel is deployed on a bottom surface of the memory board.

The first memory channel includes a plurality of first memory cells, the second memory channel includes a plurality of second memory cells, and the plurality of first memory cells and the plurality of second memory cells are in one-to-one correspondence and are laid out in a mirrored manner relative to the memory board.

In an exemplary embodiment, the first memory cell is a first memory particle, the second memory cell is a second memory particle, a plurality of first memory particles are evenly divided into N first memory ranks, and a plurality of second memory particles are evenly divided into N second memory ranks, where N is an integer greater than 2.

Each of the first memory ranks includes M first memory particles, and each of the second memory ranks includes M second memory particles.

In an exemplary embodiment, N is 2, and M is 10; or, N is 4 and M is 10.

In an exemplary embodiment, when N is 2 and M is 10, the memory expansion board meets a size specification of an E3.S hard disk board; or

when N is 4 and M is 10, the memory expansion board meets a size specification of a 3.5-inch U.2 hard disk.

In an exemplary embodiment, P of the M first memory particles are configured to process data, Q of the M first memory particles are configured to process error correcting codes, and M is a sum of P and Q.

P of the M second memory particles are configured to process data, and Q of the M second memory particles are configured to process error correcting codes.

In an exemplary embodiment, the first memory particles and the second memory particles all are dynamic memory particles of a double rate protocol 5 with a bit width of x4.

In an exemplary embodiment, each of the dynamic memory particles of the double rate protocol 5 has one of following capacities: 4 Gbit, 8 Gbit, 16 Gbit, 64 Gbit, and 128 Gbit.

In an exemplary embodiment, the first memory cell and the second memory cell both are memory particles.

One or more pairs of symmetrically-arranged data pins are deployed on each memory particle.

Each pair of data pins includes a first data pin and a second data pin.

A first data signal line on the memory expansion controller which is connected to the first data pin of the memory particle located on the top surface is also connected to the second data pin of the memory particle located on the bottom surface.

A second data signal line on the memory expansion controller which is connected to the second data pin of the memory particle located on the top surface is also connected to the first data pin of the memory particle located on the bottom surface.

In an exemplary embodiment, one or more pairs of symmetrically-arranged control pins are also deployed on each memory particle.

Each pair of control pins includes a first control pin and a second control pin.

A first control signal line on the memory expansion controller which is connected to the first control pin of the memory particle located on the top surface is also connected to the second control pin of the memory particle located on the bottom surface.

A second control signal line on the memory expansion controller which is connected to the second control pin of the memory particle located on the top surface is also connected to the first control pin of the memory particle located on the bottom surface.

In an exemplary embodiment, a mirror control pin is also deployed on each memory particle.

The memory expansion controller is further connected to the mirror control pin of each memory particle.

The memory expansion controller is configured to send a first control signal to the mirror control pin of the memory particle located on the top surface, and to send a second control signal to the mirror control pin of the memory particle located on the bottom surface, where the first control signal is used for setting the memory particle located on the top surface to operate in a default mode, and the second control signal is used for setting the memory particle located on the bottom surface to operate in a signal cross-exchange mode.

### BRIEF DESCRIPTION OF THE DRAWINGS

FIG. 1 is a schematic diagram of an optional memory module according to an embodiment of the present application;

FIG. 2 is a schematic diagram I of a memory board according to an optional embodiment of the present application;

FIG. 3 is a schematic diagram Il of a memory board according to an optional embodiment of the present application;

FIG. 4 is a schematic diagram I of a memory module according to an optional embodiment of the present application;

FIG. 5 is a schematic diagram II of a memory module according to an optional embodiment of the present application;

FIG. 6 is a schematic diagram of an optional memory expansion board of a server according to an embodiment of the present application;

FIG. 7 is a schematic diagram I of a memory expansion board of a server according to an optional embodiment of the present application; and

FIG. 8 is a schematic diagram II of a memory expansion board of a server according to an optional embodiment of the present application.

### Detailed Description of the Embodiments

Embodiments of the present application are described in detail below with reference to the drawings and in combination with the embodiments.

It should be noted that the terms “first”, “second”, and the like in the description, the claims, and the drawings above of the present application are used to distinguish between similar objects, and are not necessarily used to describe a specific sequence or sequential order.

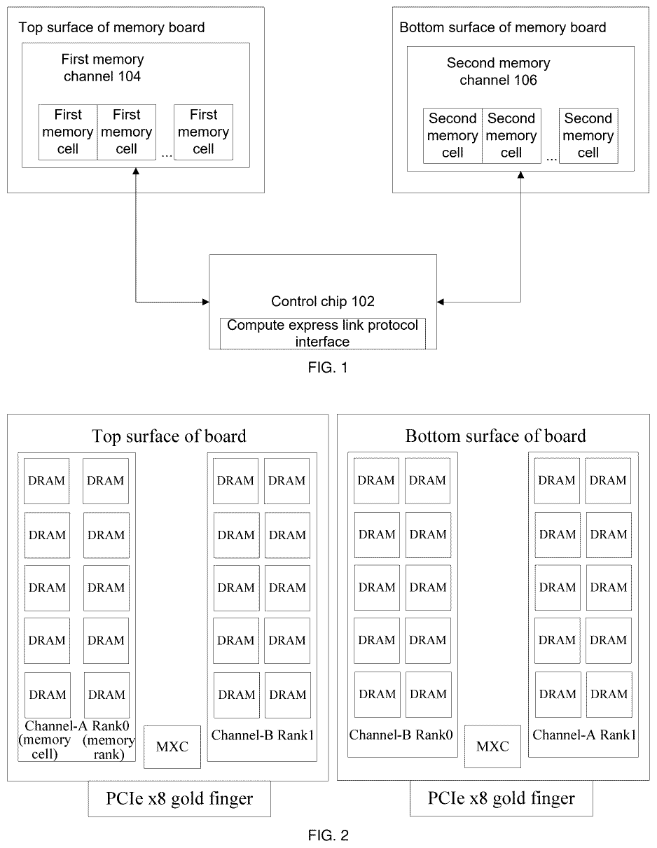

This embodiment provides a memory bank. FIG. 1 is a schematic diagram of an optional memory bank according to an embodiment of the present application. As shown in FIG. 1, the memory bank includes: a controller 102, a first memory channel 104, and a second memory channel 106, where the controller 102 is connected to each of the first memory channel 104 and the second memory channel 106, a compute express link protocol interface is deployed on the controller 102 and is configured to be connected to a device conforming to an express link protocol, and the controller 102 is configured to control the first memory channel 104 and the second memory channel 106. The first memory channel 104 is deployed on the top surface of a memory board, and the second memory channel 106 is deployed on the bottom surface of the memory board. The first memory channel 104 includes a plurality of first memory cells, the second memory channel 106 includes a plurality of second memory cells, and the plurality of first memory cells and the plurality of second memory cells are in one-to-one correspondence and are laid out in a mirrored manner relative to the memory board.

Through the memory bank above, the memory bank includes: the controller, the first memory channel, and the second memory channel, where the controller deployed with the compute express link protocol interface is connected to each of the first memory channel and the second memory channel, the first memory channel including the plurality of first memory cells is deployed on the top surface of the memory board, the second memory channel including the plurality of second memory cells is deployed on the bottom surface of the memory board, and the plurality of first memory cells and the plurality of second memory cells are in one-to-one correspondence and are laid out in the mirrored manner relative to the memory board. That is, by laying out, in the mirrored manner, the first memory channel including the plurality of first memory cells and the second memory channel including the plurality of second memory cells on the top surface of the memory board and on the bottom surface of the memory board respectively, a memory capacity of the memory board is a sum of memory capacities of the first memory channel and the second memory channel. Moreover, the mirror layout saves the size occupied by the memory cell, such that the memory capacity is increased. Then, the controller based on the compute express link protocol is connected to each of the first memory channel and the second memory channel, thereby improving a memory control capability of the controller, and improving a memory expansion capability. Therefore, the problem of low memory capacities and memory expansion capabilities is solved, thereby achieving the effect of improving the memory capacities and memory expansion capabilities.

Optionally, in this embodiment, the memory module above may be, but is not limited to be, configured to be connected to a device conforming to an express protocol, so as to control a communication between the device conforming to the express protocol and the memory module, such that the reading and writing, on the memory module, of data provided by the device conforming to the express protocol are realized, thereby improving the memory expansion capability of the device conforming to the express link protocol.

Optionally, in this embodiment, the compute express protocol may be, but is not limited to, a memory bus protocol such as a Compute Express Link (CXL, a high-speed serial protocol) protocol, etc. that may be used to connect a CPU and a device such as an Accelerator, a Memory Buffer and a Smart network interface card (NIC), so as to be used for scenarios such as Artificial Intelligence (AI) machine learning and high-performance computing. The CXL protocol may, but is not limited to, implement open industrial standards, which are used for interconnection of high-bandwidth and low-latency devices. In the embodiment of the present application, the compute express link protocol being the CXL protocol is used as an example for description.

Optionally, in this embodiment, the device conforming to the express link protocol may be, but is not limited to, a host, a CPU, a server, or the like, which supports the express link protocol.

Optionally, in this embodiment, the controller may be, but is not limited to, a memory expansion controller which supports a compute express link protocol, such as a Memory Expander Controller (MXC). The MXC may be, but is not limited to be, interconnected with the CPU through a Peripheral Component Interconnect Express 5.0 (PCIe5.0, a high-speed serial computer expansion bus standard 5.0) physical interface, and a rear stage is divided into two sub-channels, each of which may mount up to 4 ranks (memory particles connected to a same device select signal), thereby achieving the expansion of a memory capacity. In the embodiment of the present application, the controller being an MXC is used as an example for description.

Optionally, in this embodiment, the memory board may be, but is not limited to, a storage board, of which top and bottom surfaces both support the deployment of a plurality of memory cells. An electrically erasable programmable read only memory (EEPROM) may be, but is not limited to be, deployed on the memory board, and is configured to store specification data such as a capacity, a rate and a manufacturer of the memory cell. After the memory module is powered on, the specification data may be, but is not limited to be, read from the EEPROM first, and various initial configurations are then performed.

Optionally, in this embodiment, the first memory channel may include, but is not limited to, the plurality of first memory cells, which are regularly arranged in ranks; and the second memory channel may include, but is not limited to, the plurality of second memory cells, which are regularly arranged in ranks.

Optionally, in this embodiment, the plurality of first memory cells are the plurality of second memory cells may be, but are not limited to be, in a one-to-one correspondence and are laid out in a mirrored manner relative to the memory board. That is, if the first memory channel includes a plurality of first memory cells: a first memory cell 1, a first memory cell 2, a first memory cell 3, . . . , a first memory cell N, and the second memory channel includes a plurality of second memory cells: a second memory cell 1, a second memory cell 2, a second memory cell 3, . . . , a second memory cell N, the first memory cell 1 and the second memory cell 1 correspond to each other and are arranged in a mirrored manner relative to the memory board, the first memory cell 2 and the second memory cell 2 correspond to each other and are arranged in a mirrored manner relative to the memory board, the first memory cell 3 and the second memory cell 3 correspond to each other and are arranged in a mirrored manner relative to the memory board, . . . , and the first memory cell N and the second memory cell N correspond to each other and are arranged in a mirrored manner relative to the memory board.

Optionally, in this embodiment, the first memory cell and the second memory cell may be, but are not limited to, memory particles obtained after a wafer is packaged, such as Double Data Rate 5 Dynamic Random Access Memory (DDR5 DRAM) particles, and DDR4 DRAM particles. The type of memory particles is not limited in the present application. In the embodiment of the present application, using the first memory cell and the second memory cell being the DDR5 DRAM particles is used as an example for description.

Optionally, in this embodiment, the MXC (controller) may be, but is not limited to be, connected to a device conforming to the CXL protocol (compute express link protocol), and then control the first memory channel deployed on the top surface of the memory board and the second memory channel deployed on the bottom surface of the memory board, so as to implement operations such as memory reading and writing of the device. The first memory channel may include, but is not limited to, the plurality of first DDR5 DRAM particles (first memory cells), which are, with the plurality of second DDR5 DRAM particles (second memory cells), in one-to-one correspondence and are arranged in a mirrored manner relative to the memory board.

In an exemplary embodiment, the first memory cell is a first memory particle, the second memory cell is a second memory particle, the plurality of first memory particles are evenly divided into N first memory ranks, and the plurality of second memory particles are evenly divided into N second memory ranks, where N is an integer greater than 2. Each of the first memory ranks includes M first memory particles, and each of the second memory ranks includes M second memory particles.

Optionally, in this embodiment, the plurality of first memory cells may be, but are not limited to, the first DDR5 DRAM particles (first memory particles), which are evenly divided into N first ranks (first memory ranks); the plurality of second memory cells may be, but are not limited to, the second DDR5 DRAM particles (second memory particles), which are evenly divided into N second ranks (second memory ranks); each first rank may include, but is not limited to, M first DDR5 DRAM particles; and each second rank may include, but is not limited to, M second DDR5 DRAM particles.

In an exemplary embodiment, N is 2ⁿ, and n is a positive integer.

Optionally, in this embodiment, as the number of the memory cells which may be mounted on the MXC is 2ⁿ, a value of N is 2ⁿ, that is, one MXC ship may mount 2 memory modules, and 4 MXCs may mount 8 memory modules.

In an exemplary embodiment, N is 2, and M is 10; or, N is 4 and M is 10.

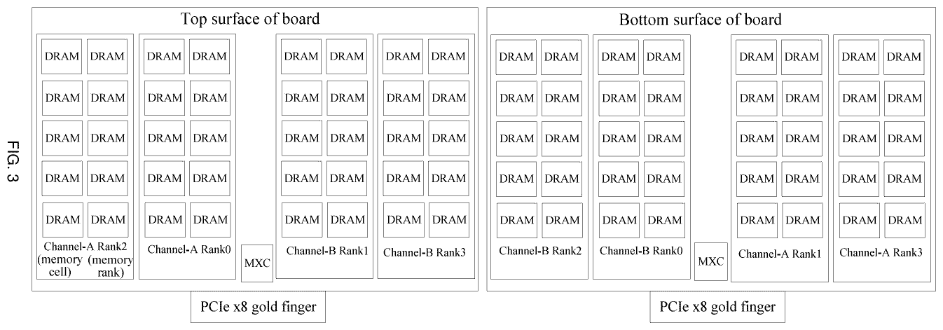

In an optional embodiment, a schematic diagram I of a memory board is provided. FIG. 2 is a schematic diagram I of a memory board according to an optional embodiment of the present application. As shown in FIG. 2, when N is 2, and M is 10, the first memory cell ChannelA is evenly divided into 2 first memory ranks: a first RANKO and a first RANK1, where the first RANK0 includes 10 first DDR5 DRAM particles, and the first RANK1 includes 10 first DDR5 DRAM particles. The second memory cell ChannelB is evenly divided into 2 second memory ranks: a second RANK0 and a second RANK1, where the second RANKO includes 10 first DDR5 DRAM particles, and the second RANK1 includes 10 first DDR5 DRAM particles.

In an optional embodiment, a schematic diagram II of a memory board is provided. FIG. 3 is a schematic diagram Il of a memory board according to an optional embodiment of the present application. As shown in FIG. 3, when N is 4, and M is 10, the first memory cell ChannelA is evenly divided into 4 first memory ranks: a first RANK0, a first RANK1, a first RANK2, and a first RANK3 each including 10 first DDR5 DRAM particles. The second memory cell ChannelB is evenly divided into 4 second memory ranks: a second RANK0, a second RANK1, a second RANK2, and a second RANK3 each including 10 first DDR5 DRAM particles.

In an exemplary embodiment, P of the M first memory particles are configured to process data, Q of the M first memory particles are configured to process error correcting codes, and M is a sum of P and Q. P of the M second memory particles are configured to process data, and Q of the M second memory particles are configured to process error correcting codes.

Optionally, in this embodiment, if M=10, 10 adjacent first DDR5 DRAM particles (first memory particles) on the same surface constitute one rank (one first memory rank), of which 8 first DDR5 DRAM particles are configured to process the data, and 2 first DDR5 DRAM particles are configured to process the error correcting codes (ECCs); and 10 adjacent second DDR5 DRAM particles (second memory particles) on the same surface constitute one rank (one second memory rank), of which 8 second DDR5 DRAM particles are configured to process the data, and 2 second DDR5 DRAM particles are configured to process the error correcting codes (ECCs). That is, when M=10, P=8, and Q=2.

In an exemplary embodiment, the first memory particles and the second memory particles all are dynamic memory particles of a double rate protocol 5 with a bit width of x4.

Optionally, in this embodiment, the double rate protocol may be, but is not limited to, a protocol which supports a higher external data transmission rate, such as a Double Data Rate (DDR) protocol.

Optionally, in this embodiment, a bit width of a single DRAM particle of a DDR5 protocol (a dynamic memory particle of a double rate protocol 5) may be, but is not limited to, x4 and x8. Four data signal lines are required between the memory particle with the bit width of x4 and the MXC, and 8 data signal lines are required between the memory particle with the bit width of x8 and the MXC. If there are more data signal lines, a routing difficult of a PCB is greater, and thus more PCB layers are required. Therefore, in the embodiments of the present application, the DRAM particles of the DDR5 protocol with the bit width of x4 are used to implement the application of the memory module.

In an exemplary embodiment, each of the dynamic memory particles of the double rate protocol 5 has one of the following capacities: 4 Gbit, 8 Gbit, 16 Gbit, 64 Gbit, and 128 Gbit.

Optionally, in this embodiment, the single memory capacity of each DRAM particle (dynamic memory particle) of the DDR5 protocol may be unlimited. Common single particle capacities include 4 Gbit, 8 Gbit, 16 Gbit, 64 Gbit, and 128 Gbit. There may be no difference in the design process of the DRAM particles of the DDR5 protocol with different capacities.

Optionally, in this embodiment, when N is 2 and M is 10, for the DDR5 DRAM particles with the bit width of x4, if the capacity of the single particle is 4 Gbit, a total capacity of the memory module may reach 16 GB; if the capacity of the single particle is 8 Gbit, the total capacity of the memory module may reach 32 GB; if the capacity of the single particle is 16 Gbit, the total capacity of the memory module may reach 64 GB; and if the capacity of the single particle is 32 Gbit, the total capacity of the memory module may reach 128 GB.

Optionally, in this embodiment, when N is 2 and M is 10, if DDR5 DRAM particles packaged by Samsung 3DS are used, and the capacity of the single particle may reach 64 Gbit, the total capacity of the memory module may reach 256 GB; and if the capacity of the single particle may reach 128 Gbit, the total capacity of the memory module may reach 512 GB.

Optionally, in this embodiment, when N is 4 and M is 10, for the DDR5 DRAM particles with the bit width of x4, if the capacity of the single particle is 4 Gbit, a total capacity of the memory module may reach 32 GB; if the capacity of the single particle is 8 Gbit, the total capacity of the memory module may reach 64 GB; if the capacity of the single particle is 16 Gbit, the total capacity of the memory module may reach 128 GB; and if the capacity of the single particle is 32 Gbit, the total capacity of the memory module may reach 256 GB.

Optionally, in this embodiment, when N is 4 and M is 10, if the DDR5 DRAM particles packaged by Samsung 3DS are used, and the capacity of the single particle is 64 Gbit, the total capacity of the memory module may reach 512 GB; and if the capacity of the single particle is 128 Gbit, the total capacity of the memory module may reach 1 TB.

In an exemplary embodiment, the first memory cell and the second memory cell both are memory particles; one or more pairs of symmetrically-arranged data pin are deployed on each memory particle; each pair of data pin includes a first data pin and a second data pin; a first data signal line on the controller which is connected to the first data pin of the memory particle located on the top surface is also connected to the second data pin of the memory particle located on the bottom surface; and a second data signal line on the controller which is connected to the second data pin of the memory particle located on the top surface is also connected to the first data pin of the memory particle located on the bottom surface.

Optionally, in this embodiment, the first data signal lines dq0 and dq2 and the second data signal lines dq1 and dq3 are deployed on the controller. Two pairs of symmetrically-arranged data pin are deployed on each memory particle. If the first pair of data pin includes a first data pin DQ0 and a second data pin DQ1, and the second pair of data pin includes a first data pin DQ2 and a second data pin DQ3, the first data signal line dq0 on the controller which is connected to the first data pin DQ0 of the memory particle located on the top surface is also connected to the second data pin DQ1 of the memory particle located on the bottom surface, the first data signal line dq2 on the controller which is connected to the first data pin DQ2 of the memory particle located on the top surface is also connected to the second data pin DQ3 of the memory particle located on the bottom surface, the second data signal line dq1 on the controller which is connected to the second data pin DQ1 of the memory particle located on the top surface is also connected to the first data pin DQ0 of the memory particle located on the bottom surface, and the second data signal line dq3 on the controller which is connected to the second data pin DQ3 of the memory particle located on the top surface is also connected to the first data pin DQ2 of the memory particle located on the bottom surface.

In an exemplary embodiment, one or more pairs of symmetrically-arranged control pin are also deployed on each memory particle; each pair of control pin includes a first control pin and a second control pin. A first control signal line on the controller which is connected to the first control pin of the memory particle located on the top surface is also connected to the second control pin of the memory particle located on the bottom surface, and a second control signal line on the controller which is connected to the second control pin of the memory particle located on the top surface is also connected to the first control pin of the memory particle located on the bottom surface.

Optionally, in this embodiment, the first control signal lines ca0 and ca2 and the second control signal lines ca1 and ca3 are deployed on the controller. Two pairs of symmetrically-arranged control pin are also deployed on each memory particle. If the first pair of control pin includes a first control pin CA0 and a second control pin CA1, and the second pair of control pin includes a first control pin CA2 and a second control pin CA3, the first control signal line ca0 on the controller which is connected to the first control pin CA0 of the memory particle located on the top surface is also connected to the second control pin CA1 of the memory particle located on the bottom surface, the first control signal line ca2 on the controller which is connected to the first control pin CA2 of the memory particle located on the top surface is also connected to the second control pin CA3 of the memory particle located on the bottom surface, the second control signal line ca1 on the controller which is connected to the second control pin CA1 of the memory particle located on the top surface is also connected to the first control pin CA0 of the memory particle located on the bottom surface, and the second control signal line ca3 on the controller which is connected to the second control pin CA3 of the memory particle located on the top surface is also connected to the first control pin CA2 of the memory particle located on the bottom surface.

In an exemplary embodiment, a mirror control pin is also deployed on each memory particle. The controller is also connected to the mirror control pin of each memory particle, and is configured to send a first control signal to the mirror control pin of the memory particle located on the top surface, and to send a second control signal to the mirror control pin of the memory particle located on the bottom surface, where the first control signal is used for setting the memory particle located on the top surface to operate in a default mode, and the second control signal is used for setting the memory particle located on the bottom surface to operate in a signal cross-exchange mode.

Optionally, in this embodiment, the mirror control pin deployed on each memory particle may be, but is not limited to be, configured to completely lay out, in a mirrored manner, the memory particles on the top surface and bottom surface of the board, such that the signal pins of the memory particles on the top surface and the bottom surface are crossed left and right.

Optionally, in this embodiment, the signal lines of the memory particles on the top surface are connected normally, thereby ensuring that the first control signal is used for setting the memory particles located on the top surface to operate in the default mode; and the signal lines of the memory particles on the bottom surface are exchanged in pairs, thereby ensuring that the second control signal is used for setting the memory particles located on the bottom surface to operate in the signal cross-exchange mode.

Optionally, in this embodiment, for the controller: since the signal interconnection between the memory particles on the bottom surface of the memory board and the MXC is crossed, MIR pins of the memory particles need to be pulled up on a hardware circuit, such that the memory particles on the bottom surface are automatically set to “signals being cross-exchanged within themselves” during initialization. MIR pins of the memory particles on the top surface are pulled down, and the signals are not cross-exchanged internally, thereby ensuring that the control logics on the top surface and bottom surface of the memory board are consistent.

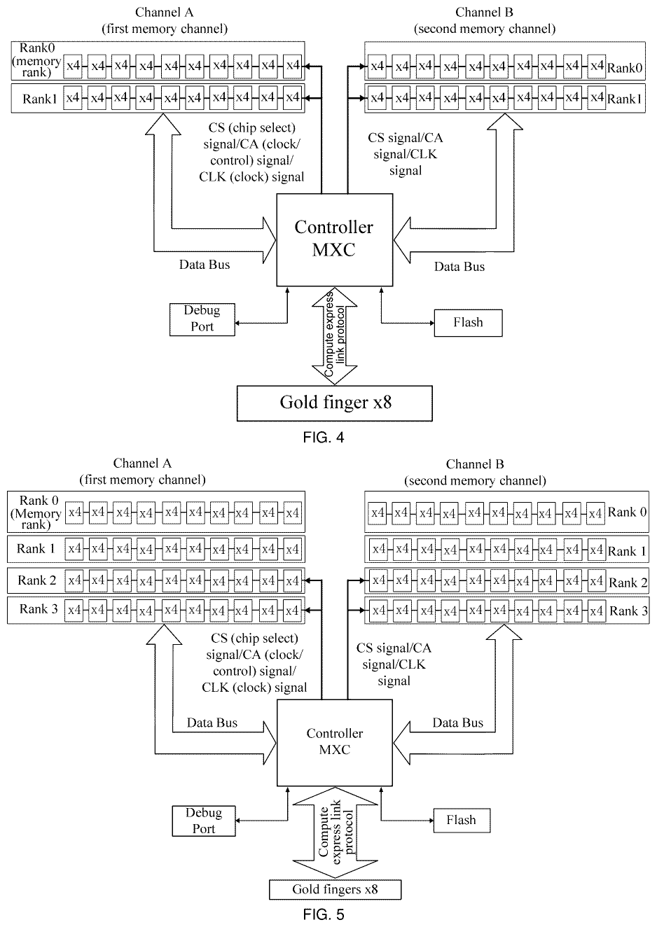

In an optional embodiment, a schematic diagram I of a memory module is provided. FIG. 4 is a schematic diagram I of a memory module according to an optional embodiment of the present application. As shown in FIG. 4, the controller MXC is connected to each of the first memory channel ChannelA and the second memory channel ChannelB through a data bus. The CXL interface (compute express link protocol interface) is deployed on the controller MXC. The CXL interface is configured to be connected to the device conforming to the compute express link protocol. The first memory channel ChannelA is deployed on the top surface of the memory board, and the second memory channel ChannelB is deployed on the bottom surface of the memory board. The first memory channel ChannelA includes 2 first memory cells: RANK0 and RANK1, and the second memory channel ChannelB includes 2 second memory cells: RANK0 and RANK1. The 2 first memory cells and the 2 second memory cells are in one-to-one correspondence and are laid out in a mirrored manner relative to the memory board. In this case, N=2, and M=10.

Optionally, in this embodiment, the board of the first type of memory module may be, but is not limited to be, interconnected with a mainboard through a PCIe x8 gold fingers, and a SMBus on the gold fingers may realize the communication between the MXC and a mainboard host; a Flash provides firmware to the MXC; and a debug port is configured for single-board debugging. The board of the memory module is mounted with an MXC and 40 DDR5 DRAM particles with a bit width of x4; 20 DDR5 DRAM particles are arranged on the top surface of the board, and 20 DDR5 DRAM particles are also arranged on the bottom surface; the DDR5 DRAM particles on both surfaces of the board are laid out in a mirrored manner and arranged symmetrically; 10 adjacent DDR 5 DRAM particles on the same surface constitute one rank, of which 8 DDR5 DRAM particles are configured to process data, and 2 DDR5 DRAM particles are configured to process ECCs; and the ranks on the left and right sides of the MXC correspond to the Channel A and the Channel B respectively.

In an optional embodiment, a schematic diagram Il of a memory module is provided. FIG. 5 is a schematic diagram II of a memory module according to an optional embodiment of the present application. As shown in FIG. 5, the controller MXC is connected to each of the first memory channel ChannelA and the second memory channel ChannelB through a data bus. The CXL interface (compute express link protocol interface) is deployed on the controller MXC. The CXL interface is configured to be connected to the device conforming to the compute express link protocol. The first memory channel ChannelA is deployed on the top surface of the memory board, and the second memory channel ChannelB is deployed on the bottom surface of the memory board. The first memory channel ChannelA includes 4 first memory cells: RANK0, RANK1, RANK2, and RANK3, and the second memory channel ChannelB includes 4 second memory cells: RANK0, RANK1, RANK2, and RANK3. The 4 first memory cells and the 4 second memory cells are in one-to-one correspondence and are laid out in a mirrored manner relative to the memory board. In this case, N=4, and M=10.

Optionally, in this embodiment, the board of the second type of memory module is also interconnected with the mainboard through a Peripheral Component Interconnect Express x8 (PCIe x8, an 8- bit high-speed serial computer expansion bus standard) gold fingers. A System Management Bus (SMBus) on the gold fingers may realize the communication between the MXC and the mainboard host; a Flash (non-volatile readable storage medium) provides firmware to the MXC; and a debug port is configured for single-board debugging. The board of the second type of memory module is mounted with an MXC and 80 DDR5 DRAM particles with a bit width of x4; and the second type of memory module is designed with 4 ranks on each of the Channel A and the Channel B. Compared with the first type of memory module, the number of the DRAM particles is doubled.

Optionally, in this embodiment, if the memory module in the embodiment of the present application is mounted on a PCIe5.0 interface of a device supporting the CXL protocol, the memory capacity and bandwidth of a CPU of the device may be greatly expanded on the basis of the CXL protocol, and the PCIe5.0 interface and MXC are used to expand a large-capacity memory for the CPU, so as to meet the demands of computing nodes.

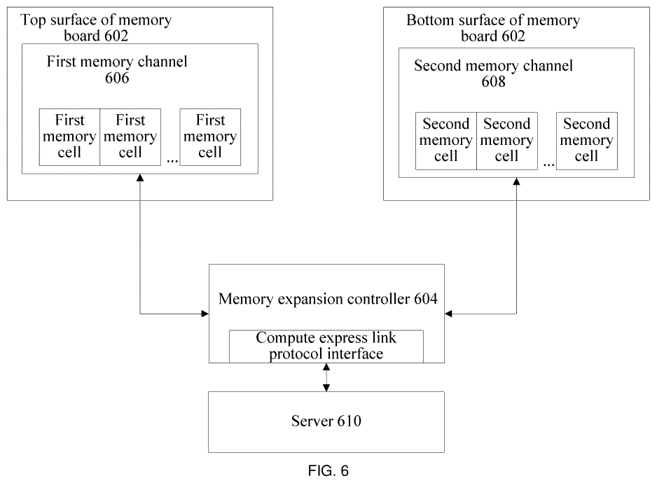

This embodiment further provides a memory expansion board of a server. FIG. 6 is a schematic diagram of an optional memory expansion board of a server according to an embodiment of the present application. The memory expansion board includes: a memory board 602, a memory expansion controller 604, a first memory channel 606, and a second memory 608.

The memory expansion controller 604 is connected to each of the first memory channel 606 and the second memory channel 608, and a compute express link protocol interface is deployed on the memory expansion controller 604, and is configured to be connected to a server 610.

The memory expansion controller 604 and the first memory channel 606 are deployed on a top surface of the memory board 602, and the second memory channel 608 is deployed on a bottom surface of the memory board 602.

The first memory channel 606 includes a plurality of first memory cells, the second memory channel 608 includes a plurality of second memory cells, and the plurality of first memory cells and the plurality of second memory cells are in one-to-one correspondence and are laid out in a mirrored manner relative to the memory board.

Through the memory expansion board of a server as described above, by laying out, in a mirrored manner, the first memory channel including the plurality of first memory cells and the second memory channel including the plurality of second memory cells on the top surface and the bottom surface of the memory board respectively, a memory capacity of the memory board is a sum of memory capacities of the first memory channel and the second memory channel. Moreover, the mirror layout saves the size occupied by the memory cell, such that the memory capacity is increased. Then, the memory expansion controller on the basis of the compute express link protocol is connected to each of the first memory channel and the second memory channel, thereby improving a memory control capability of the memory expansion controller and improving a memory expansion capability. Therefore, the problem of low memory capacities and memory expansion capabilities is solved, thereby achieving the effect of improving the memory capacities and memory expansion capabilities.

Optionally, in this embodiment, the memory board of a server as described above may be, but is not limited to be, configured to be connected to a server conforming to an express protocol, so as to control a communication between the server conforming to the express protocol and the memory module, such that the reading and writing, on the memory board, of data provided by the server conforming to the express protocol are realized, thereby improving the memory expansion capability of the server conforming to the express link protocol.

Optionally, in this embodiment, a compute express protocol may be, but is not limited to, a memory bus protocol such as a Compute Express Link (CXL) protocol, etc. that may be used to connect a CPU and a device such as an Accelerator, a Memory Buffer and a Smart NIC, so as to be used for scenarios such as Al machine learning and high-performance computing. The CXL protocol may, but is not limited to, implement open industrial standards, which are used for interconnection of high-bandwidth and low-latency devices. In the embodiment of the present application, the compute express link protocol being the CXL protocol is used as an example for description.

Optionally, in this embodiment, the memory expansion controller may be, but is not limited to, a memory expansion controller that supports a compute express link protocol, such as a Memory Expander Controller (MXC). The MXC may be, but is not limited to be, interconnected with the CPU through a PCIe5.0 physical interface, and a rear stage is divided into two sub-channels, each of which may mount up to 4 ranks, thereby achieving expansion of a memory capacity. In the embodiment of the present application, the controller being an MXC is used as an example for description.

Optionally, in this embodiment, the memory board may be, but is not limited to, a storage board, of which top and bottom surfaces both support the deployment of a plurality of memory cells. An EEPROM may be, but is not limited to be, deployed on the memory board, and is configured to store specification data such as a capacity, a rate, and a manufacturer of the memory cell. After the memory module is powered on, the specification data may be, but is not limited to be, read from the EEPROM first, and various initial configurations are then performed.

Optionally, in this embodiment, the first memory channel may include, but is not limited to, the plurality of first memory cells, which are regularly arranged in ranks; and the second memory channel may include, but is not limited to, the plurality of second memory cells, which are regularly arranged in ranks.

Optionally, in this embodiment, the plurality of first memory cells are the plurality of second memory cells may be, but are not limited to be, in a one-to-one correspondence and are laid out in a mirrored manner relative to the memory board. That is, if the first memory channel includes a plurality of first memory cells: a first memory cell 1, a first memory cell 2, a first memory cell 3, . . . , a first memory cell N, and the second memory channel includes a plurality of second memory cells: a second memory cell 1, a second memory cell 2, a second memory cell 3, . . . , a second memory cell N, the first memory cell 1 and the second memory cell 1 correspond to each other and are arranged in a mirrored manner relative to the memory board, the first memory cell 2 and the second memory cell 2 correspond to each other and are arranged in a mirrored manner relative to the memory board, the first memory cell 3 and the second memory cell 3 correspond to each other and are arranged in a mirrored manner relative to the memory board, . . . , and the first memory cell N and the second memory cell N correspond to each other and are arranged in a mirrored manner relative to the memory board.

Optionally, in this embodiment, the first memory cell and the second memory cell may be, but are not limited to, memory particles obtained after a wafer is packaged, such as DDR5 DRAM particles, and DDR4 DRAM particles. The type of memory particles is not limited in the present application. In the embodiment of the present application, using the first memory cell and the second memory cell being the DDR5 DRAM particles is used as an example for description.

Optionally, in this embodiment, the MXC (memory expansion controller) may be, but is not limited to be, connected to a server conforming to the CXL protocol (compute express link protocol), and then control the first memory channel deployed on the top surface of the memory board and the second memory channel deployed on the bottom surface of the memory board, so as to implement operations such as memory reading and writing of the server. The first memory channel may include, but is not limited to, the plurality of first DDR5 DRAM particles (first memory cells), which are, with the plurality of second DDR5 DRAM particles (second memory cells), in one-to-one correspondence and are arranged in a mirrored manner relative to the memory board.

In an exemplary embodiment, the first memory cell is a first memory particle, the second memory cell is a second memory particle, the plurality of first memory particles are evenly divided into N first memory ranks, and the plurality of second memory particles are evenly divided into N second memory ranks, where N is an integer greater than 2. Each of the first memory ranks includes M first memory particles, and each of the second memory ranks includes M second memory particles.

Optionally, in this embodiment, the plurality of first memory cells may be, but are not limited to, the first DDR5 DRAM particles (first memory particles), which are evenly divided into N first ranks (first memory ranks); the plurality of second memory cells may be, but are not limited to, the second DDR5 DRAM particles (second memory particles), which are evenly divided into N second ranks (second memory ranks); each first rank may include, but is not limited to, M first DDR5 DRAM particles; and each second rank may include, but is not limited to, M second DDR5 DRAM particles. In an exemplary embodiment, N is 2, and M is 10; or, N is 4 and M is 10.

Optionally, in this embodiment, when N is 2 and M is 10, the first memory cell and the second memory cell in the memory board of the server are evenly divided into 2 ranks, each of which includes 10 DDR5 DRAM particles.

Optionally, in this embodiment, when N is 4 and M is 10, the first memory cell and the second memory cell in the memory board of the server are evenly divided into 4 ranks, each of which includes 10 DDR5 DRAM particles.

In an exemplary embodiment, when N is 2 and M is 10, the memory expansion board meets a size specification of an E3.S hard disk board; or when N is 4 and M is 10, the memory expansion board meets a size specification of a 3.5-inch U.2 hard disk.

Optionally, in this embodiment, when N is 2 and M is 10, the memory expansion board may be, but is not limited to be, in a form of an E3.S hard disk. It is estimated that the power consumption of the memory expansion board of a server is about 25 W, which is less than a 40 W power consumption limit specified by a disk in an E3.S form. Compared with existing memory expansion boards, the memory expansion board of a server has a smaller factor size, is thinner as a whole, and is easily deployed on front and rear windows of the server, facilitating the plugging and unplugging operations, maintenance, and switching of the memory expansion board of a server.

Optionally, in this embodiment, when N is 4 and M is 10, the memory expansion board may be, but is not limited to be, in a form of a 3.5-inch U.2 hard disk, and thus is easily deployed on the front and rear windows of the server, facilitating the plugging and unplugging operations, maintenance, and switching of the memory module.

Optionally, in this embodiment, a structure size of the E3.S disk is 112.75*76*16.8 mm. Since the MXC may only use a PCIE x8 interface, according to the size design of a printed circuit board (PCB) layout and structure, the E3.S disk may only accommodate one MXC and 40 memory particles. If there are no limitations in terms of a board size, more MXCs may theoretically be used to expand to a larger memory capacity.

Optionally, in this embodiment, the size of the E3.S disk is 112.75*76*16.8 mm, and the size of the 3.5-inch U.2 disk is 147*102*26 mm. These two disks are of size specifications that are commonly used in servers and are smaller than the sizes of existing memory module expansion cards, facilitating dense deployment in the front and rear windows of the server.

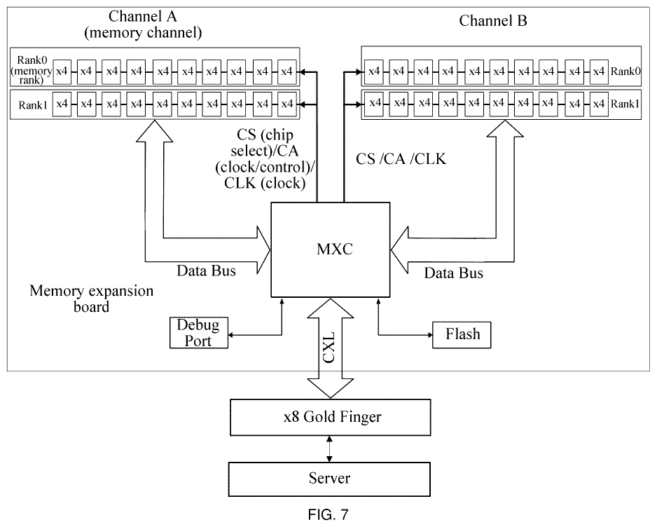

In an optional embodiment, a schematic diagram I of a memory expansion board of a server is provided. FIG. 7 is a schematic diagram I of a memory expansion board of a server according to an optional embodiment of the present application. As shown in FIG. 7, the server and the memory expansion board are connected through x8 Gold fingers. When N is 2 and M is 10, the first memory cell ChannelA is evenly divided into 2 first memory ranks: a first RANK0 and a first RANK1, where the first RANKO includes 10 first DDR5 DRAM particles, and the first RANK1 includes 10 first DDR5 DRAM particles. The second memory cell ChannelB is evenly divided into 2 second memory ranks: a second RANK0 and a second RANK1, where the second RANK0 includes 10 first DDR5 DRAM particles, and the second RANK1 includes 10 first DDR5 DRAM particles.

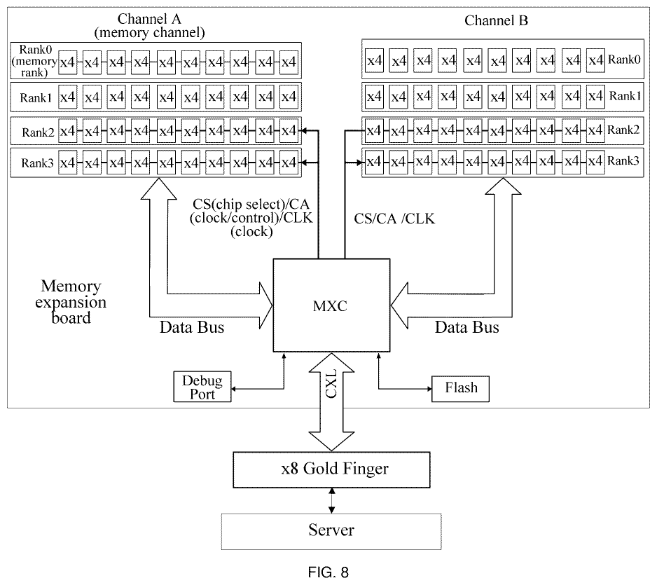

In an optional embodiment, a schematic diagram II of a memory expansion board of a server is provided. FIG. 8 is a schematic diagram II of a memory expansion board of a server according to an optional embodiment of the present application. As shown in FIG. 8, the server and the memory expansion board are connected through x8 Gold fingers. When N is 4 and M is 10, the first memory cell ChannelA is evenly divided into 4 first memory ranks: a first RANK0, a first RANK1, a first RANK2, and a first RANK3 each including 10 first DDR5 DRAM particles. The second memory cell ChannelB is evenly divided into 2 second memory ranks: a second RANK0, a second RANK1, a second RANK2, and a second RANK3 each including 10 first DDR5 DRAM particles.

In an exemplary embodiment, P of the M first memory particles are configured to process data, Q of the M first memory particles are configured to process error correcting codes, and M is a sum of P and Q. P of the M second memory particles are configured to process data, and Q of the M second memory particles are configured to process error correcting codes.

Optionally, in this embodiment, if M=10, 10 adjacent first DDR5 DRAM particles (first memory particles) on the same surface constitute one rank (one first memory rank), of which 8 first DDR5 DRAM particles are configured to process the data, and 2 first DDR5 DRAM particles are configured to process the error correcting codes (ECCs); and 10 adjacent second DDR5 DRAM particles (second memory particles) on the same surface constitute one rank (one second memory rank), of which 8 second DDR5 DRAM particles are configured to process the data, and 2 second DDR5 DRAM particles are configured to process the error correcting codes (ECCs). That is, when M=10, P=8, and Q=2.

In an exemplary embodiment, the first memory particles and the second memory particles all are dynamic memory particles of a double rate protocol 5 with a bit width of x4.

Optionally, in this embodiment, the double rate protocol may be, but is not limited to, a protocol which supports a higher external data transmission rate, such as a Double Data Rate (DDR) protocol.

Optionally, in this embodiment, a bit width of a single DRAM particle of a DDR5 protocol (a dynamic memory particle of a double rate protocol 5) may be, but is not limited to, x4 and x8. Four data signal lines are required between the memory particle with the bit width of x4 and the MXC, and 8 data signal lines are required between the memory particle with the bit width of x8 and the MXC. If there are more data signal lines, a routing difficult of a PCB is greater, and thus more PCB layers are required. Therefore, in the embodiment of the present application, the DRAM particles of the DDR5 protocol with the bit width of x4 are used to implement the application of the memory expansion board of a server.

In an exemplary embodiment, each of the dynamic memory particles of the double rate protocol 5 has one of the following capacities: 4 Gbit, 8 Gbit, 16 Gbit, 64 Gbit, and 128 Gbit.

Optionally, in this embodiment, the single memory capacity of each DRAM particle (dynamic memory particle) of the DDR5 protocol may be unlimited. Common single particle capacities include 4 Gbit, 8 Gbit, 16 Gbit, 64 Gbit, and 128 Gbit. There may be no difference in the design process of the DRAM particles of the DDR5 protocol with different capacities.

Optionally, in this embodiment, when N is 2 and M is 10, for the DDR5 DRAM particles with the bit width of x4, if the capacity of the single particle is 4 Gbit, a total capacity of the memory expansion board of a server may reach 16 GB; if the capacity of the single particle is 8 Gbit, the total capacity of the memory expansion board of a server may reach 32 GB; if the capacity of the single particle is 16 Gbit, the total capacity of the memory expansion board of a server may reach 64 GB; and if the capacity of the single particle is 32 Gbit, the total capacity of the memory expansion board of a server may reach 128 GB.

Optionally, in this embodiment, when N is 2 and M is 10, if DDR5 DRAM particles packaged by Samsung 3DS are used, and the capacity of the single particle may reach 64 Gbit, the total capacity of the memory expansion board of a server may reach 256 GB; and if the capacity of the single particle may reach 128 Gbit, the total capacity of the memory expansion board of a server may reach 512 GB.

Optionally, in this embodiment, when N is 4 and M is 10, for the DDR5 DRAM particles with the bit width of x4, if the capacity of the single particle is 4 Gbit, a total capacity of the memory expansion board of a server may reach 32 GB; if the capacity of the single particle is 8 Gbit, the total capacity of the memory expansion board of a server may reach 64 GB; if the capacity of the single particle is 16 Gbit, the total capacity of the memory expansion board of a server may reach 128 GB; and if the capacity of the single particle is 32 Gbit, the total capacity of the memory expansion board of a server may reach 256 GB.

Optionally, in this embodiment, when N is 4 and M is 10, if the DDR5 DRAM particles packaged by Samsung 3DS are used, and the capacity of the single particle is 64 Gbit, the total capacity of the memory expansion board of a server may reach 512 GB; and if the capacity of the single particle is 128 Gbit, the total capacity of the memory expansion board of a server may reach 1 TB.

In an exemplary embodiment, the first memory cell and the second memory cell both are memory particles; one or more pairs of symmetrically-arranged data pins are deployed on each memory particle; each pair of data pins includes a first data pin and a second data pin; a first data signal line on the memory expansion controller which is connected to the first data pin of the memory particle located on the top surface is also connected to the second data pin of the memory particle located on the bottom surface; and a second data signal line on the memory expansion controller which is connected to the second data pin of the memory particle located on the top surface is also connected to the first data pin of the memory particle located on the bottom surface.

Optionally, in this embodiment, the first data signal lines dq0 and dq2 and the second data signal lines dq1 and dq3 are deployed on the memory expansion controller. Two pairs of symmetrically-arranged data pins are deployed on each memory particle. If the first pair of data pins includes a first data pin DQ0 and a second data pin DQ1, and the second pair of data pins includes a first data pin DQ2 and a second data pin DQ3, the first data signal line dq0 on the controller which is connected to the first data pin DQ0 of the memory particle located on the top surface is also connected to the second data pin DQ1 of the memory particle located on the bottom surface, the first data signal line dq2 on the controller which is connected to the first data pin DQ2 of the memory particle located on the top surface is also connected to the second data pin DQ3 of the memory particle located on the bottom surface, the second data signal line dq1 on the controller which is connected to the second data pin DQ1 of the memory particle located on the top surface is also connected to the first data pin DQ0 of the memory particle located on the bottom surface, and the second data signal line dq3 on the controller which is connected to the second data pin DQ3 of the memory particle located on the top surface is also connected to the first data pin DQ2 of the memory particle located on the bottom surface.

In an exemplary embodiment, one or more pairs of symmetrically-arranged control pins are also deployed on each memory particle; each pair of control pins includes a first control pin and a second control pin. A first control signal line on the memory expansion controller which is connected to the first control pin of the memory particle located on the top surface is also connected to the second control pin of the memory particle located on the bottom surface, and a second control signal line on the memory expansion controller which is connected to the second control pin of the memory particle located on the top surface is also connected to the first control pin of the memory particle located on the bottom surface.

Optionally, in this embodiment, the first control signal lines ca0 and ca2 and the second control signal lines ca1 and ca3 are deployed on the memory expansion controller. Two pairs of symmetrically-arranged control pins are also deployed on each memory particle. If the first pair of control pins includes a first control pin CA0 and a second control pin CA1, and the second pair of control pins includes a first control pin CA2 and a second control pin CA3, the first control signal line ca0 on the controller which is connected to the first control pin CA0 of the memory particle located on the top surface is also connected to the second control pin CA1 of the memory particle located on the bottom surface, the first control signal line ca2 on the controller which is connected to the first control pin CA2 of the memory particle located on the top surface is also connected to the second control pin CA3 of the memory particle located on the bottom surface, the second control signal line ca1 on the controller which is connected to the second control pin CA1 of the memory particle located on the top surface is also connected to the first control pin CAO of the memory particle located on the bottom surface, and the second control signal line ca3 on the controller which is connected to the second control pin CA3 of the memory particle located on the top surface is also connected to the first control pin CA2 of the memory particle located on the bottom surface.

In an exemplary embodiment, a mirror control pin is also deployed on each memory particle, and the memory expansion controller is also connected to the mirror control pin of each memory particle, and is configured to send a first control signal to the mirror control pin of the memory particle located on the top surface, and to send a second control signal to the mirror control pin of the memory particle located on the bottom surface, where the first control signal is used for setting the memory particle located on the top surface to operate in a default mode, and the second control signal is used for setting the memory particle located on the bottom surface to operate in a signal cross-exchange mode.

Optionally, in this embodiment, the mirror control pin deployed on each memory particle may be, but is not limited to be, configured to completely lay out, in a mirrored manner, the memory particles on the top surface and bottom surface of the board, such that the signal pins of the memory particles on the top surface and the bottom surface are crossed left and right.

Optionally, in this embodiment, the signal lines of the memory particles on the top surface are connected normally, thereby ensuring that the first control signal is used for setting the memory particles located on the top surface to operate in the default mode; and the signal lines of the memory particles on the bottom surface are exchanged in pairs, thereby ensuring that the second control signal is used for setting the memory particles located on the bottom surface to operate in the signal cross-exchange mode.

Optionally, in this embodiment, for the memory expansion controller: since the signal interconnection between the memory particles on the bottom surface of the memory board and the MXC is crossed, MIR pins of the memory particles need to be pulled up on a hardware circuit, such that the memory particles on the bottom surface are automatically set to “signals being cross-exchanged within themselves” during initialization. MIR pins of the memory particles on the top surface are pulled down, and the signals are not cross-exchanged internally, thereby ensuring that the control logics on the top surface and bottom surface of the memory board are consistent. Optionally, in this embodiment, the memory expansion board of a server is designed to be in the size and form of an E3.S or 3.5-inch U.2 hard disk, and thus is easily deployed in high-density computing nodes. Furthermore, on the basis of the CXL protocol, the PCIe5.0 interface and the MXC are used to expand a large-capacity memory for the server, such that the technical effect of improving the memory capacity and memory expansion capability of the server is achieved.

Optional examples in this embodiment may refer to the examples described in the above embodiments and the exemplary embodiments, and are no longer repeated here in this embodiment.

Apparently, those skilled in the art should understand that the modules or steps above of the present application may be implemented with a general-purpose computing apparatus. The modules or steps may be centralized on a single computing apparatus or distributed on a network formed by a plurality of computing apparatuses, may be implemented with program codes executable by the computing apparatus, and thus may be stored in a storage apparatus and executed by the computing apparatus. Moreover, in some cases, the steps shown or described may be performed in an order different from the order here or be separately produced as individual integrated circuit modules, or a plurality of the modules or steps may be produced and implemented as a single integrated circuit module. As such, the present application is not limited to any particular combination of hardware and software.

The embodiments above are merely optional embodiments of the present application and are not intended to limit the present application. For those skilled in the art, the present application may have various modifications and variations. Any modification, equivalent substitution, improvement and the like made within the principle of the present application shall all fall in the scope of protection of the present application.

1. A memory module, comprising a controller, a first memory channel, and a second memory channel, wherein
the controller is connected to each of the first memory channel and the second memory channel, and a compute express link protocol interface is deployed on the controller and is configured to be connected to a device conforming to a compute express link protocol;
the first memory channel is deployed on a top surface of a memory board, and the second memory channel is deployed on a bottom surface of the memory board; and
the first memory channel comprises a plurality of first memory cells, the second memory channel comprises a plurality of second memory cells, and the plurality of first memory cells and the plurality of second memory cells are in one-to-one correspondence and are laid out in a mirrored manner relative to the memory board.

2. The memory module according to claim 1, wherein the first memory cell is a first memory particle, the second memory cell is a second memory particle, a plurality of first memory particles are evenly divided into N first memory ranks, and a plurality of second memory particles are evenly divided into N second memory ranks, wherein N is an integer greater than 2; and
each of the first memory ranks comprises M first memory particles, and each of the second memory ranks comprises M second memory particles.

3. The memory module according to claim 2, wherein N is 2n, and n is a positive integer.

4. The memory module according to claim 2, wherein N is 2, and M is 10; or N is 4, and M is 10.

5. The memory module according to claim 2, wherein P of the M first memory particles are configured to process data, Q of the M first memory particles are configured to process error correcting codes, and M is a sum of P and Q; and
P of the M second memory particles are configured to process data, and Q of the M second memory particles are configured to process error correcting codes.

6. The memory module according to claim 2, wherein the first memory particles and the second memory particles all are dynamic memory particles of a double rate protocol 5 with a bit width of x4.

7. The memory module according to claim 6, wherein each of the dynamic memory particles of the double rate protocol 5 has one of following capacities: 4 Gbit, 8 Gbit, 16 Gbit, 64 Gbit, and 128 Gbit.

8. The memory module according to claim 1, wherein the first memory cell and the second memory cell both are memory particles;
one or more pairs of symmetrically-arranged data pins are deployed on each memory particle;
each pair of data pins comprises a first data pin and a second data pin;
a first data signal line on the controller which is connected to the first data pin of the memory particle located on the top surface is also connected to the second data pin of the memory particle located on the bottom surface; and
a second data signal line on the controller which is connected to the second data pin of the memory particle located on the top surface is also connected to the first data pin of the memory particle located on the bottom surface.

9. The memory module according to claim 8, wherein one or more pairs of symmetrically-arranged control pins are also deployed on each memory particle;
each pair of control pins comprises a first control pin and a second control pin;
a first control signal line on the controller which is connected to the first control pin of the memory particle located on the top surface is also connected to the second control pin of the memory particle located on the bottom surface; and
a second control signal line on the controller which is connected to the second control pin of the memory particle located on the top surface is also connected to the first control pin of the memory particle located on the bottom surface.

10. The memory module according to claim 9, wherein a mirror control pin is further deployed on each memory particle;
the controller is further connected to the mirror control pin of each memory particle; and
the controller is configured to send a first control signal to the mirror control pin of the memory particle located on the top surface, and to send a second control signal to the mirror control pin of the memory particle located on the bottom surface, wherein the first control signal is used for setting the memory particle located on the top surface to operate in a default mode, and the second control signal is used for setting the memory particle located on the bottom surface to operate in a signal cross-exchange mode.

11. A memory expansion board of a server, comprising: a memory board, a memory expansion controller, a first memory channel, and a second memory channel, wherein
the memory expansion controller is connected to each of the first memory channel and the second memory channel, and a compute express link protocol interface is deployed on the memory expansion controller and is configured to be connected to a server;
the memory expansion controller and the first memory channel are deployed on a top surface of the memory board, and the second memory channel is deployed on a bottom surface of the memory board; and
the first memory channel comprises a plurality of first memory cells, the second memory channel comprises a plurality of second memory cells, and the plurality of first memory cells and the plurality of second memory cells are in one-to-one correspondence and are laid out in a mirrored manner relative to the memory board.

12. The memory expansion board according to claim 11, wherein the first memory cell is a first memory particle, the second memory cell is a second memory particle, a plurality of first memory particles are evenly divided into N first memory ranks, and a plurality of second memory particles are evenly divided into N second memory ranks, wherein N is an integer greater than 2; and
each of the first memory ranks comprises M first memory particles, and each of the second memory ranks comprises M second memory particles.

13. The memory expansion board according to claim 12, wherein N is 2, and M is 10; or N is 4, and M is 10.

14. The memory expansion board according to claim 13, wherein when N is 2 and M is 10, the memory expansion board meets a size specification of an E3.S hard disk board; or
when N is 4 and M is 10, the memory expansion board meets a size specification of a 3.5-inch U.2 hard disk.

15. The memory expansion board according to claim 12, wherein P of the M first memory particles are configured to process data, Q of the M first memory particles are configured to process error correcting codes, and M is a sum of P and Q; and
P of the M second memory particles are configured to process data, and Q of the M second memory particles are configured to process error correcting codes.

16. The memory expansion board according to claim 12, wherein the first memory particles and the second memory particles all are dynamic memory particles of a double rate protocol 5 with a bit width of x4.

17. The memory expansion board according to claim 16, wherein each of the dynamic memory particles of the double rate protocol 5 has one of following capacities: 4 Gbit, 8 Gbit, 16 Gbit, 64 Gbit, and 128 Gbit.

18. The memory expansion board according to claim 11, wherein the first memory cell and the second memory cell both are memory particles;
one or more pairs of symmetrically-arranged data pins are deployed on each memory particle;
each pair of data pins comprises a first data pin and a second data pin;
a first data signal line on the memory expansion controller which is connected to the first data pin of the memory particle located on the top surface is also connected to the second data pin of the memory particle located on the bottom surface; and
a second data signal line on the memory expansion controller which is connected to the second data pin of the memory particle located on the top surface is also connected to the first data pin of the memory particle located on the bottom surface.

19. The memory expansion board according to claim 18, wherein one or more pairs of symmetrically-arranged control pins are also deployed on each memory particle;
each pair of control pins comprises a first control pin and a second control pin;
a first control signal line on the memory expansion controller which is connected to the first control pin of the memory particle located on the top surface is also connected to the second control pin of the memory particle located on the bottom surface; and
a second control signal line on the memory expansion controller which is connected to the second control pin of the memory particle located on the top surface is also connected to the first control pin of the memory particle located on the bottom surface.

20. The memory expansion board according to claim 19, wherein a mirror control pin is further deployed on each memory particle;
the memory expansion controller is further connected to the mirror control pin of each memory particle; and
the memory expansion controller is configured to send a first control signal to the mirror control pin of the memory particle located on the top surface, and to send a second control signal to the mirror control pin of the memory particle located on the bottom surface, wherein the first control signal is used for setting the memory particle located on the top surface to operate in a default mode, and the second control signal is used for setting the memory particle located on the bottom surface to operate in a signal cross-exchange mode.
